(19) United States
(12) Patent Application Publication
(10) Pub. No.: US 2023/0349333 A1
(43) Pub. Date: Nov. 2, 2023

(54) TELESCOPIC CONNECTING ROD FOR A VARIABLE COMPRESSION RATIO ENGINE

(71) Applicant: MCE 5 Development, Villeurbanne (FR)

(72) Inventors: René-Pierre Bertheau, Amberieux-en-Dombes (FR); Sylvain Bigot, Pau (FR)

(21) Appl. No.: 17/756,954

(22) PCT Filed: Dec. 4, 2020
(86) PCT No.: PCT/FR2020/052281

§ 371 Date: Jun. 6, 2022

(30) Foreign Application Priority Data
Dec. 5, 2019 (FR) FR1913799

(51) Int. Cl. F02D 15/02; F02B 75/04; F01M 1/06; F01M 11/02; F01M 1/16

(52) U.S. Cl. CPC F02D 15/02; F02B 75/048; F01M 1/06; F01M 11/02; F01M 1/16; F01M 2001/066; F01M 2011/025

(57) ABSTRACT

A telescopic control connecting rod for a variable compression ratio engine, comprises: a small end having, respectively, an eye and a piston at its ends; a big end serving as cylinder body in which the piston defines a first and a second hydraulic chamber, and a third side chamber located between the first and the second hydraulic chambers; the big end comprises two coaxial side bearings configured to establish a pivot link with a fixed part of the engine; a lubrication circuit comprising at least a first duct provided in the big end, connecting an inner space of each side bearing and the third chamber, whatever the length of the connecting rod, and comprising at least one second duct provided in the small end, connecting the third chamber and the eye.

### CROSS-REFERENCE TO RELATED APPLICATIONS

This application is a national phase entry under 35 U.S.C. § 371 of International Patent Application PCT/FR2020/052281, filed Dec. 4, 2020, designating the United States of America and published as International Patent Publication WO 2021/111089 A1 on Jun. 10, 2021, which claims the benefit under Article 8 of the Patent Cooperation Treaty to French Patent Application Serial No. FR1913799, filed Dec. 5, 2019.

### TECHNICAL FIELD

The present disclosure relates to the field of variable compression ratio engines comprising a system for controlling the ratio. The disclosure relates, in particular, to a telescopic connecting rod included in the control system.

### BACKGROUND

Among the different variable compression ratio engine architectures, there is an engine called VC-T (“variable compression-turbo”) developed by the Nissan group and described, in particular, in document EP2787196. It comprises four cylinders and four combustion pistons 10. Each combustion piston 10 is connected to a return member 12 by a main connecting rod 11 (FIG. 1). The return member 12 comprises three axes of rotation parallel to the axis of rotation x of the crankshaft 13, to establish three pivot links 12a, 12b, 12c with the main connecting rod 11, with a crankpin of the crankshaft 13 and with the small end 20a of a control connecting rod 20, respectively. The big end 20b of the control connecting rod 20 is mounted on an eccentric shaft 22 with an axis parallel to the axis of rotation x of the crankshaft 13. The four control connecting rods 20, associated with the four combustion pistons 10, establish a pivot link with the eccentric shaft 22. The latter comprises a central lever 23 connected to one end of a tie rod 24, the other end of the tie rod 24 being connected to another lever 25 integrated into an electric control means 26, for example, an arm movable in rotation actuated by a motor.

These various components can be classified into two distinct groups:
The mobile coupling 1 integrating the combustion pistons 10, the main connecting rods 11, the return members 12 and the crankshaft 13,
The control system 2 integrating the control connecting rods 20, the eccentric shaft 22, the levers 23, 25, the tie rod 24 and the electric control means 26.

When the movable lever 25 of the electric control means 26 is actuated, the tie rod 24 changes position, and causes the rotation of the eccentric shaft 22 about its own axis, simultaneously modifying the position of the four control connecting rods 20. The new position of the control connecting rods 20 induces a change in position of the return members 12. The third pivot link 12c, which each return member 12 establishes with each control connecting rod 20, changes position in the plane (y, z) normal to the axis x of the crankshaft 13 under the effect of the traction or the thrust of the control connecting rod 20; the first pivot link 12a of each return member 12 is then moved in the plane (y, z) by lever effect, which causes the stroke of all the combustion pistons 10 in the cylinders to change.

Such a control system 2, therefore, makes it possible to vary the compression ratio of the engine 100. It nevertheless has the drawback of controlling the pistons of the four cylinders in an inseparable manner, which can impact the energy performance of the engine 100.

Document DE102010019756 describes a variable compression ratio engine comprising a mobile coupling 1 similar to the one described above. The control system 2 is different, however; it incorporates adjustment devices comparable to variable length control connecting rods, the big ends of which are in a pivot link, each connected independently with the engine block. Varying the length of an adjustment device modifies the position of the return member connected to the other end of the device, which causes the stroke of the associated combustion piston to change. The compression ratio of each piston can thus be controlled independently by the associated control connecting rod.

This solution nevertheless remains complex and expensive to implement because the size of the components in the engine and their assembly requires specific arrangements and processes.

There is, therefore, a need, in an engine architecture as mentioned above, for a control system that is simple, compact and reliable and that facilitates engine assembly.

### BRIEF SUMMARY

The present disclosure works to achieve all or part of the aforementioned objectives by proposing a telescopic control connecting rod included in a control system for controlling a variable combustion ratio engine.

The disclosure relates to a telescopic control connecting rod for a variable compression ratio engine, comprising:
a small end with a longitudinal axis, having, at one end, an eye intended to establish a pivot link with a return member of the engine and having, at the other end, a piston, and
a big end serving as cylinder body in which the piston defines a first and a second hydraulic chamber, the respective filling and emptying of which modify the length of the connecting rod, and a third side chamber located between the first and the second chamber; the big end further comprising two coaxial side bearings, with a transverse axis normal to the longitudinal axis, intended to establish a pivot link with a fixed part of the engine;
a lubrication circuit comprising at least a first duct provided in the big end, establishing fluidic communication between an inner space of each side bearing and the third chamber, whatever the length of the connecting rod, and comprising at least one second duct provided in the small end, in fluidic communication with the third chamber and opening into the eye.

According to other advantageous and non-limiting features of the disclosure, taken alone or in any technically feasible combination:
each side bearing has a shoulder to ensure positioning along the transverse axis of the connecting rod with respect to the fixed part of the engine;
the third chamber has an annular shape, to facilitate free passage of the oil from the lubrication circuit between the two side bearings of the connecting rod;
the connecting rod comprises a spacer attached to each side bearing and intended to be secured to the fixed part of the engine, each spacer comprising at least one supply duct intended to supply the inner space of the side bearing with oil and to lubricate an external surface of the side bearing, when the connecting rod is mounted in the engine;
the connecting rod comprises a stepped ring inserted between a side bearing and its attached spacer, to limit the friction associated with the oscillating movement of the control rod relative to the fixed part of the engine;
the connecting rod comprises a control circuit, independent of the lubrication circuit, for establishing or closing fluidic communication between the first chamber and the second chamber;
the control circuit comprises a first hydraulic slide valve and a second hydraulic slide valve, respectively housed in the first and the second side bearing of the connecting rod:
   a displacement of the first hydraulic slide valve making it possible to establish an oil circulation from the first chamber to the second chamber, via passages arranged in the big end,
   a displacement of the second hydraulic slide valve making it possible to establish a circulation of oil from the second chamber to the first chamber, via other passages arranged in the big end;
each hydraulic slide valve is intended to be in contact via a ball with a control piston carried by the fixed part of the engine, each control piston being able to be moved by an oil pressure of a drive circuit, independent of the lubrication circuit and the control circuit, to induce the movement of the associated slide valve;
the connecting rod comprises a refill circuit comprising at least one bore and a non-return valve, so as to allow oil to circulate from the third chamber to one of the other two chambers;
the connecting rod comprises a discharge circuit comprising at least one bore and a non-return valve between the first or the second chamber and the exterior of the connecting rod, so as to discharge oil from the control circuit when the pressure in the circuit exceeds a determined maximum pressure.

### BRIEF DESCRIPTION OF THE DRAWINGS

Other features and advantages of the disclosure will become apparent from the following detailed description of the disclosure, with reference to the accompanying figures, in which:

FIG. 1 shows a mobile coupling and a control system for the variable compression ratio in an engine according to the state of the art;

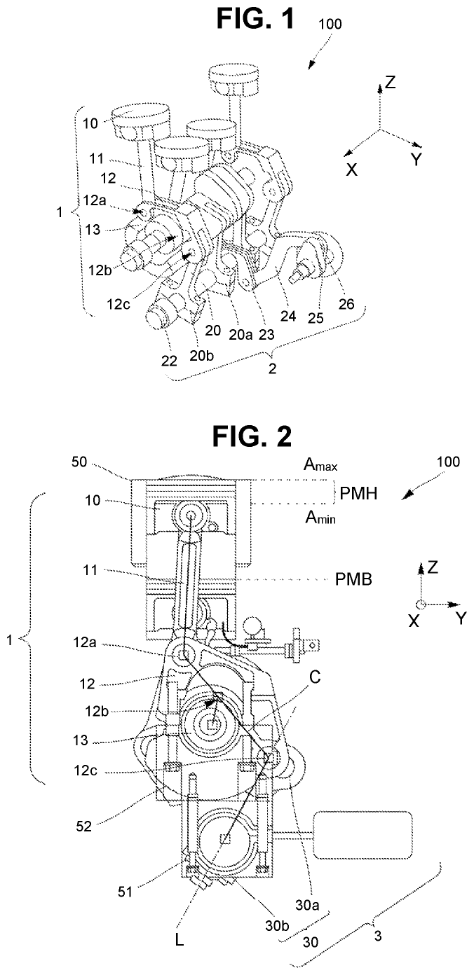

FIG. 2 shows a side view of a mobile coupling and of a control system for a variable compression ratio engine, the system including a control connecting rod according to the disclosure;

FIGS. 3A and 3B show a control connecting rod for a variable compression ratio engine according to the disclosure;

FIGS. 4A and 4B show a plurality of contiguous control connecting rods, intended for a variable compression ratio engine, and conforming, respectively, to a first (FIG. 4A) and a second (FIG. 4B) embodiment of the disclosure; these figures, in particular, illustrate the lubrication circuit of the control connecting rods;

FIGS. 5A and 5B show all or part of a control connecting rod for a variable compression ratio engine, according to a first embodiment of the disclosure;

FIGS. 6 and 7 show a control connecting rod according to a first embodiment of the disclosure, in particular, illustrating the control circuit and the drive circuit of the rod; and

FIGS. 8A, 8B, 9A, and 9B show a control connecting rod according to a second embodiment of the disclosure, in particular, illustrating the control circuit and the drive circuit of the connecting rod.

### DETAILED DESCRIPTION

In the descriptive part, the same references in the figures may be used for the same type of elements or elements having the same function. The figures are schematic representations whereof certain details, for the sake of readability, are not necessarily to scale.

The disclosure will be described in the context of a variable compression ratio engine 100 comprising a mobile coupling 1 as described in the introductory part and briefly recalled below.

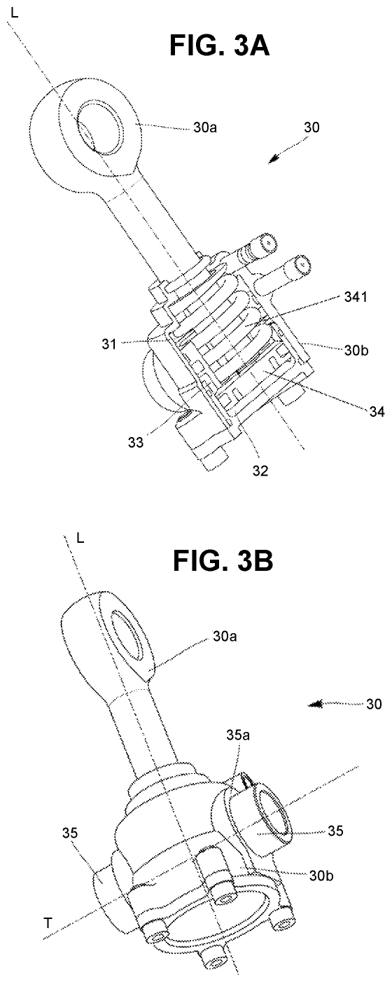

As illustrated in FIG. 2, the mobile coupling 1 comprises a crankshaft 13, at least one combustion piston 10 intended to slide in a combustion cylinder 50 (partially shown in FIG. 2). Cylinder 50 is integrated into an engine block (not shown).

The combustion piston 10 is intended to move between a bottom dead center PMB and a top dead center PMH. As is well known, top dead center PMH corresponds to the moment when the combustion piston 10 is at the highest point of its stroke in the cylinder 50, just before it goes back in the other direction. In the case of a variable compression ratio engine, the top dead center PMH can be reached at different altitudes: for the maximum compression ratio, the top dead center PMH will be at the maximum altitude Amax; for the minimum compression ratio, the top dead center PMH will be located at the altitude Amin, and for an intermediate compression ratio, it will be located between these two altitudes Amax, Amin.

The mobile coupling 1 comprises at least one main connecting rod 11 connected at one end to the combustion piston 10. It also comprises at least one return member 12 connected, on the one hand, to the other end of the main connecting rod 11, on the other hand, to a crankpin of the crankshaft 13, and lastly, to a small end 30a of a control connecting rod 30. More particularly, the return member 12 has three axes of rotation to establish a first pivot link 12a, a second pivot link 12b and a third pivot link 12c with the main connecting rod 11, with the crankpin of the crankshaft 13 and with the small end 30a of the control connecting rod 30 (described below), respectively.

The engine 100 also comprises a compression ratio control system 3. Compression ratio control system 3 comprises at least one variable length control connecting rod 30, associated with a combustion piston 10. Modifying the length of the control connecting rod 30 makes it possible to modify the altitude of the top dead center PMH of the combustion piston 10 in its cylinder 50, in order to vary the compression ratio of the engine. Indeed, since the big end 30b of the control connecting rod 30 establishes a pivot link along an axis normal to the plane (x, y) with a fixed part 51 secured to the engine block, the variation in length of the control connecting rod 30 will modify the position, in the plane (y, z), of the third pivot link 12c of the return member 12 and consequently the position of the first pivot link 12a: this causes the stroke of the associated combustion piston 10 to change, i.e., in other words, the altitude of the top dead center PMH of the combustion piston 10.

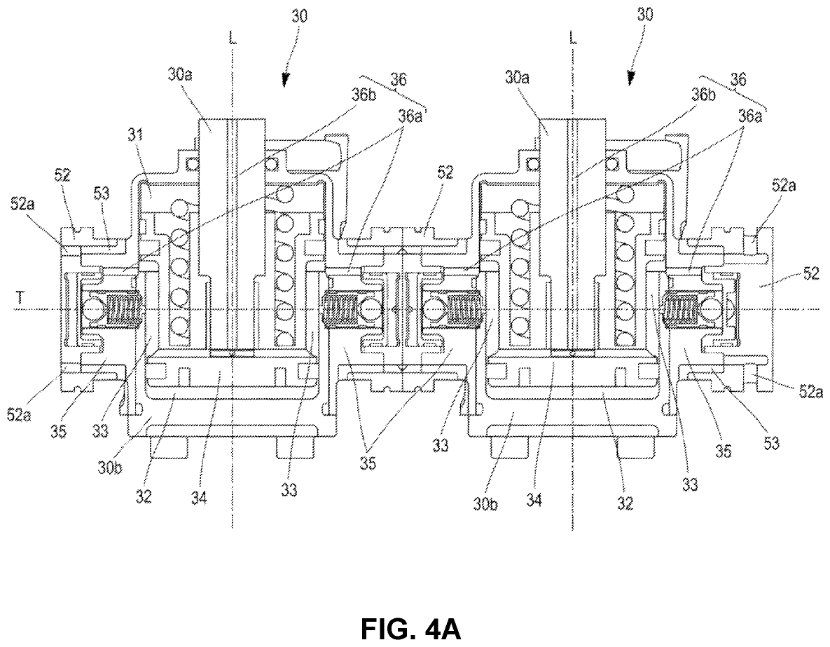

The control connecting rod 30 according to the disclosure is a telescopic connecting rod having a small end 30a and a big end 30b. Its small end 30a extends along a longitudinal axis L, and has, at one of its ends, an eye in which the return member 12 is housed at its third pivot link 12c. The small end 30a of the control connecting rod 30 comprises, at its other end, a hydraulic piston 34 able to slide in a cylinder body arranged in the big end 30b of the control connecting rod 30 (FIG. 3A). A first chamber 31 and a second chamber 32 are defined in the cylinder body, on either side of the hydraulic piston 34 that incorporates seals. The first chamber 31 is called “high-pressure chamber” because it takes up the combustion forces; in contrast, the second chamber 32 is called the “low-pressure chamber.” The respective filling and emptying of the first 31 and second 32 hydraulic chambers modify the length of the control connecting rod 30.

Advantageously, the control connecting rod 30 comprises a return device 341, tending to bring it back to a minimum length, corresponding here to the maximum compression ratio of the engine. This makes it possible to apply an additional force (in addition to the inertia forces that are applied during operation of the engine) to the hydraulic piston 34, and thus to increase the speed of position change toward a maximum compression ratio.

The big end 30b of the control connecting rod 30 comprises the cylinder bore in its internal part; this bore is closed by a cover attached, for example, by means of four screws. Preferably, the hydraulic piston 34 is provided so as to have equivalent sections at the first and second chambers 31, 32.

The hydraulic piston 34 also defines a third side chamber 33, located between the first chamber 31 and the second chamber 32. It is called “side” because it is arranged between the internal side walls of the cylinder body and those of the hydraulic piston 34.

The big end 30b of the control connecting rod 30 comprises two coaxial side bearings 35 with a transverse axis T normal to the longitudinal axis L (FIG. 3B). These side bearings 35 are intended to establish a pivot link with a fixed part 51 secured to the engine block. The side position of the side bearings 35 makes it possible to compact the control connecting rod 30 with respect to a conventional cylinder with the connection points at the ends, thus limiting the size in the engine block. Advantageously, each side bearing 35 has a shoulder 35a to ensure positioning of the control connecting rod 30, along the transverse axis T, with respect to the fixed part 51 of the engine. It should be recalled that the transverse axis T is intended to be parallel to the axis x of the crankshaft 13, when the control connecting rod 30 is mounted in the engine 100.

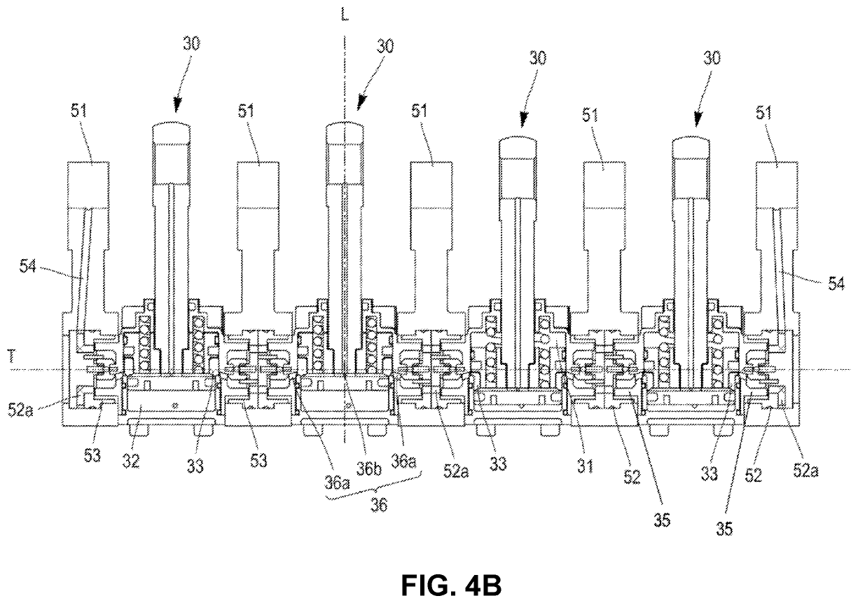

The control connecting rod 30 according to the disclosure further comprises a lubrication circuit 36 (FIGS. 4A, 4B). As its name indicates, this lubrication circuit 36 is supplied with a lubricating oil at low pressure, typically between 2 and 6 bars. It comprises at least a first duct 36a arranged in the big end 30b, establishing fluidic communication between an inner space of each side bearing 35 and the third chamber 33, whatever the length of the control connecting rod 30. Advantageously, the third chamber 33 has an annular shape, to facilitate free passage of the oil from the lubrication circuit between the two side bearings 35 of the control connecting rod 30.

The arrival of the lubricating oil from the fixed part 51 of the engine to the inner space of each side bearing 35 will be described later.

The lubrication circuit 36 comprises at least one second duct 36b arranged in the small end 30a, in fluidic communication with the third chamber 33 and opening into the eye.

This ingenious architecture of the control connecting rod 30 allows oil to be routed from the side bearings 35 to the eye, for the lubrication of the third pivot link 12c of the latter with the return member 12.

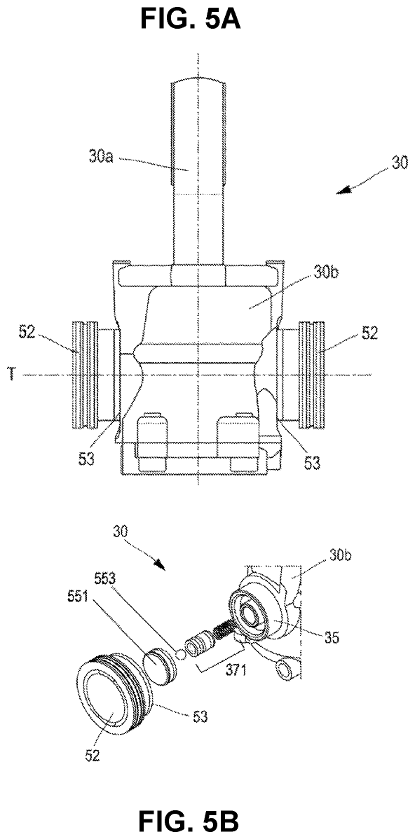

Advantageously, the control connecting rod 30 comprises a spacer 52 attached to each side bearing 35, illustrated in FIGS. 5A and 5B. The added spacers 52 are intended to be secured to the fixed part 51 of the engine. It is recalled that the fixed part 51 is secured to the block supporting the crankshaft 13. The link between the side bearings 35 and the added spacers 52 allows the oscillating movement of the control connecting rod 30 necessary for the operation of the compression ratio control system 3 in the engine 100. To this end, each added spacer 52 has a cylindrical inner housing, to accommodate a side bearing 35. The outer enclosure of the spacer 52 may also be cylindrical. It may nevertheless be advantageous to provide an ovoid outer enclosure to block any rotational movement of the spacer 52 with respect to the fixed part 51 of the engine. Provision can also be made for the inner housing accommodating a side bearing 35 to be eccentric with respect to the central axis of the outer enclosure of the added spacer 52, which will be chosen in this case as cylindrical or ovoid: this also provides an anti-rotation function.

Preferably, the control connecting rod 30 comprises a stepped ring 53 inserted between each side bearing 35 and its attached spacer 52, to limit the friction associated with the oscillating movement of the control connecting rod 30 with respect to the fixed part 51 of the engine, and to partially take up the combustion forces as well as the inertia forces of the mobile coupling 1. The stepped ring 53 can, for example, be formed from a material such as steel or bronze.

Each added spacer 52 comprises at least one supply duct 52a intended to convey the lubricating oil into the inner space of the side bearing 35 and onto an external surface of the side bearing 35, when the control connecting rod 30 is mounted in the engine 100.

As can be seen in FIG. 4B, the external low-pressure lubricating oil supply 54, coming from the fixed part 51 of the engine, thus communicates with the supply duct 52a of the attached spacer 52, which communicates with an inner space of a side bearing 35, for conveying the lubricating oil to the third chamber 33 (via the first duct 36a of the lubrication circuit 36), and with an external space of a side bearing 35, for lubricating the pivot link between the control connecting rod 30 and the fixed part 51 of the engine.

In an engine 100 comprising, for example, four control connecting rods 30 (to control four combustion pistons), all the added spacers 52 may comprise a supply duct 52a in direct fluidic communication with the external oil supply 54 of lubricating oil (general supply circuit of the engine 100). Alternatively, and preferably, only the added spacer 52 of the first control connecting rod 30 at one end of the alignment of the four big ends 30b, and the added spacer 52 of the fourth control connecting rod 30 at the other end, comprise a supply duct 52a in direct fluidic communication with the external low-pressure lubricating oil supply 54 (FIG. 4B). The respective supply duct 52a of the other attached spacers 52, which are placed side by side due to the alignment of the four big ends 30b, communicates with the duct 52a of the adjacent spacer 52: this allows the oil to circulate in the lubrication circuits 36 of all the control connecting rods 30, via the inner space of the side bearings 35 and the third chambers 33. The lubrication circuit 36 internal to the entire line of rotation of the control connecting rods 30 also supplies each small end 30a, as stated previously, via the second duct 36b connecting each third chamber 33 to an eye.

Note that the presence of the added spacers 52 facilitates the mounting of the control connecting rod(s) 30 in the engine 100. Indeed, they allow an individual insertion of each telescopic control connecting rod 30 in the fitted bearings of the cylinder block (fixed part 51 of the engine). Without the presence of these spacers 52, it would be necessary to mount all the control connecting rods 30 on the cylinder block at the same time.

The control connecting rod 30 advantageously comprises a control circuit 37, independent of the lubrication circuit 36, to establish or close fluidic communication between the first chamber 31 and the second chamber 32, and to allow the transfer of fluid (oil in the case at hand) from one chamber to another.

“Independent of the lubrication circuit 36” means that the control circuit 37 is capable of having an oil pressure different from that of the lubrication circuit 36, in this case a higher pressure. It will nevertheless be seen that these two circuits can communicate via a so-called refill valve, authorizing the circulation of oil from the lubrication circuit 36 to the control circuit 37, when the pressure in the latter drops below the oil pressure in the lubrication circuit 36.

The oil circulating in the control circuit 37 here, therefore, has the same nature as the lubricating oil.

As is easily understood, the supply of oil to the first chamber 31 and the emptying of the second chamber 32 controls the control connecting rod 30 toward its minimum length; conversely, the supply of oil to the second chamber 32 and the emptying of the first chamber 31 controls the control connecting rod 30 toward its maximum length. Finally, with the blocking of the fluid circulation between the first and second chambers 31, 32, the control connecting rod 30 can remain at an intermediate length.

In general, the control circuit 37 comprises oil passages (37a, 37b), for example, in the form of bores made in the big end 30b, causing the first 31 and second 32 hydraulic chambers to communicate with each other. The control circuit 37 also comprises fluidic distributors, preferably carried by the big end 30b, making it possible to open or close the oil passages and to manage the direction of circulation of the oil between the first and second chambers 31, 32. There are many ways to implement such a control circuit 37.

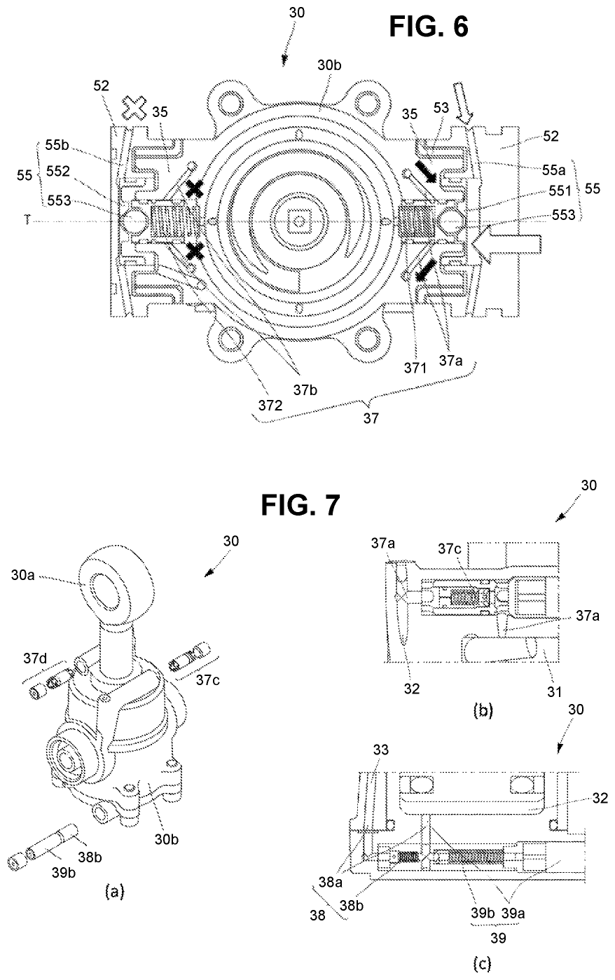

According to a first advantageous embodiment illustrated in FIGS. 5B and 6, the hydraulic control circuit 37 comprises a first hydraulic slide valve 371 and a second hydraulic slide valve 372, respectively housed in the first side bearing 35 and the second side bearing 35 of the connecting rod. Preferably, the two slide valves are arranged along the transverse axis T, coaxially with the side bearings 35. This orientation prevents the hydraulic slide valves 371, 372 from being subjected to inertial and/or combustion forces applied to the control connecting rod 30, which could interfere with the actuation of the slide valves.

A movement along the transverse axis T of the first hydraulic slide valve 371 makes it possible, for example, to establish an oil circulation (shown schematically by the black arrows in FIG. 6) from the first chamber 31 to the second chamber 32, via first oil passages 37a arranged in the big end 30b. In practice, the movement of the first slide valve 371 puts the first oil passages 37a leading to the first and second chambers 31, 32 into communication, and a first non-return valve 37c is arranged on the first oil passages 37a, only allowing circulation of fluid from the first chamber 31 to the second chamber 32 (FIGS. 7, Panels (a), (b)).

A movement of the second hydraulic slide valve 372 makes it possible to establish a circulation of oil from the second chamber 32 to the first chamber 31, via second oil passages 37b arranged in the big end 30b. In practice, the movement of the second slide valve 372 puts the second oil passages 37b leading to the first and second chambers 31, 32 into communication, and a second non-return valve 37d is arranged on the second oil passages 37b, only allowing a circulation of fluid from the second chamber 32 toward the first chamber 31.

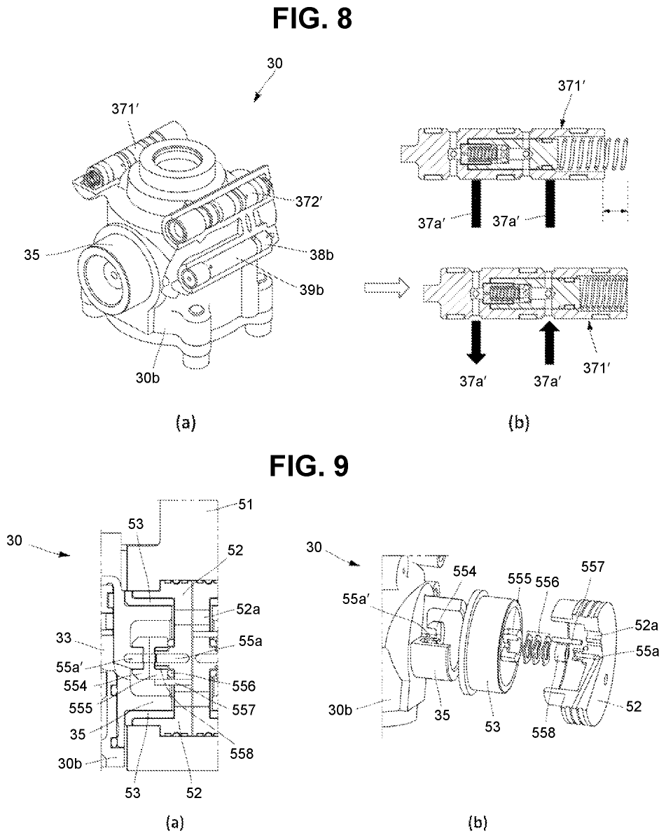

According to a second embodiment illustrated in FIG. 8, the hydraulic control circuit 37 comprises a first hydraulic slide valve 371′ and a second hydraulic slide valve 372′, each housed in the big end 30b. Preferably, the two slide valves are arranged parallel to the transverse axis T. As mentioned above, this orientation prevents the hydraulic slide valves 371, 372 from being subjected to the inertia and/or combustion forces applied to the control connecting rod 30.

Each hydraulic slide valve 371′, 372′ advantageously comprises a non-return valve mechanism, which only allows oil to circulate in one direction (FIG. 8, Panel (b)). In their rest position, the slide valves 371′, 372′ block any communication between the first and second chambers 31, 32. A movement along the transverse axis T of the first hydraulic slide valve 371′ in its housing makes it possible, for example, to establish a circulation of oil from the first chamber 31 to the second chamber 32, via first oil passages 37a′ arranged in the big end 30b. In practice, the movement of the first slide valve 371′ connects the first passages 37a′ leading to the two chambers 31, 32, only allowing a flow of fluid from the first chamber 31 to the second chamber 32. In the same way, a movement of the second hydraulic slide valve 372′ makes it possible to establish a circulation of oil from the second chamber 32 to the first chamber 31, via second passages 37b arranged in the big end 30b.

In one or other of the embodiments described, to generate the movement of the hydraulic slide valves 371, 372, 371′, 372′, and more generally, the actuation of the fluidic distributors of the control circuit 37, the control connecting rod 30 according to the disclosure implements another hydraulic circuit, called drive circuit 55. The drive circuit 55 is supplied with a pressurized fluid (air, gas, oil or other liquid) coming from the fixed part 51 of the engine.

According to a first option, the fluidic distributors of the control circuit 37 can be actuated mechanically. Such an option can be advantageous in that it avoids sometimes complex management of the sealing between fixed and mobile parts. In particular, in the first embodiment stated above, the movement of the hydraulic slide valves 371, 372 is controlled by mechanical actuation. To this end, each hydraulic slide valve 371, 372 is intended to be in contact via a ball 553 with a control piston 551, 552 carried by the fixed part 51 of the engine, and more particularly carried by the added spacer 52.

Each control piston 551, 552 can be moved by the oil pressure (shown schematically by the white arrows in FIG. 6) in the drive circuit 55, independent of the lubrication circuit 36 and of the control circuit 37, to induce the displacement of the associated hydraulic slide valve 371, 372. The drive circuit 55 here is totally external to the control connecting rod 30. The oil in this drive circuit 55 is routed via ducts 55a, 55b from the fixed part 51 of the engine to an inner housing of each added spacer 52, which housing accommodates the control piston 551, 552.

The mechanical contact between the control piston 551, 552 and the hydraulic slide valve 371, 372 is ensured by a ball 553, which is capable of accommodating the oscillation of the control connecting rod 30 with respect to the fixed elements of the engine, including, in particular, with respect to the control piston 551, 552. This configuration, therefore, provides a simple and robust solution for external control of the hydraulic control circuit 37 of the control connecting rod 30.

According to a second option, the drive circuit 55 establishes a fluidic connection between the fixed part 51 and the side bearings 35 of the control connecting rod 30 movable in rotation. In particular, in the second embodiment stated above, the movement of the hydraulic slide valves 371, 372 is controlled by fluidic actuation. Such a connection can be made, for example, as shown in FIG. 9, Panels (a) and (b), using oscillating joints between fixed and moving parts. To this end, each hydraulic slide valve 371′, 372′ is intended to be moved by the oil pressure of the drive circuit 55. Ducts 55a′ are arranged in the big end 30b from a central point of a first side bearing 35 to the first slide valve 371′ and from a central point of a second side bearing 35 to the second slide valve 372′. Ducts 55a are also arranged in the added spacer 52 and communicate with the fixed part 51 of the engine. The fluidic connection between a duct 55a′ of the moving part (control connecting rod 30) and a duct 55a of the fixed part 51 is established via two rings 554, 555 centered on the ducts 55a′, 55a, the contact faces of which are ground (FIG. 9, Panels (a), (b)). A first ring 554 is secured to the side bearing 35, a second ring 555 is carried by the added spacer 52 and can swivel slightly on its axis because it is mounted on an externally domed ring 558, absorbing any geometry defects between the faces in contact. The movement of the second ring 555 is limited to an axial movement owing to the presence of a pin 557. The contact between the two faces of the first 554 and second 555 rings is continuous owing to the combined action of the springs 556 and because of the oil pressure inside the rings 554, 555, which is greater than the pressure outside the rings 554, 555.

Each hydraulic slide valve 371′, 372′ can thus be moved by the oil pressure (shown schematically by the white arrow in FIG. 8, Panel (b)) in the drive circuit 55, independent of the lubrication circuit 36 and the control circuit 37.

As mentioned above, the control connecting rod 30 can, moreover, comprise a refill circuit 38 comprising at least one bore 38a and a non-return valve 38b, between the third chamber 33 and one of the two other chambers 31, 32 (FIG. 7, Panels (a) and (c), FIG. 8, Panel (a)). The non-return valve 38b is configured so as to allow a circulation of oil from the third chamber 33 toward one of the two other chambers 31, 32 (toward the second chamber 32 in the example of FIG. 7, Panel (c)), when the pressure in the first and second chambers 31, 32 is lower than the pressure in the third chamber 33. Such a configuration is advantageous in that the third chamber 33, supplied by the lubrication circuit 36, is used to re-supply the control circuit 37, when the pressure in the first and second chambers 31, 32 connected to the refill circuit 38 passes below the lubricating oil pressure. The object of this refill circuit 38 is to raise the average pressure in the first and second chambers 31 and 32 above the supply pressure available in the third chamber 33 owing to the pump effect generated by the alternation of the forces. It also makes it possible to compensate for any leaks in the system. The refilling is effective due to the proximity between the third chamber 33 and one of the other two chambers 31, 32.

Preferably, the refill circuit will be made to communicate with the second chamber 32, that is to say, the one that is not subjected to the combustion forces transmitted by the mobile coupling 1 because generally the forces generated by the combustion are greater than those generated by the inertias, which means that the second chamber 32 will experience the greatest depression and the lowest instantaneous pressure, thus improving the refilling.

The control connecting rod 30 may further comprise a discharge circuit 39 comprising at least one bore 39a and a non-return valve 39b between the first 31 or the second 32 hydraulic chambers and the outside of the control connecting rod 30, so as to discharge oil from the control circuit 37, when the pressure in the circuit 37 exceeds a determined maximum pressure. It is possible, for example, to choose a non-return valve 39b whose opening pressure is greater than 200 bars or 300 bars. The role of such a discharge circuit 39 is to limit the average pressure increase in the control circuit 37 and, in particular, in the first 31 and the second 32 hydraulic chambers. The instantaneous pressures in the first and second chambers 31, 32, which pass through peaks due to transmitted inertia and/or combustion forces, are also limited, which allows existing and efficient sealing solutions at a lower cost for the control connecting rod 30.

The control system according to the present disclosure, for a variable compression ratio engine, comprises one or more control connecting rod(s) 30 as previously described. The mobile coupling 1 of the engine 100 described in the introduction, integrating the combustion pistons 10, the main connecting rods 11, the return members 12 and the crankshaft 13, can remain unchanged, as can the upper part of the engine. The shape of the telescopic control connecting rods is designed to fit into the current size of the engine, thus avoiding increasing the center distance of the engine 100.

Of course, the disclosure is not limited to the embodiments and examples described and it is possible to add variants without departing from the scope of the invention as defined by the claims.

1. A telescopic control connecting rod for a variable compression ratio engine, comprising:
a small end with a longitudinal axis, having, at one end, an eye configured to establish a pivot link with a return member of the engine and having, at the other end, piston;
a big end serving as cylinder body in which the piston defines a first hydraulic chamber and a second hydraulic chamber, the respective filling and emptying of which modify length of the control connecting rod, and a third side chamber located between the first hydraulic chamber and the second hydraulic chamber; the big end further comprising two coaxial side bearings, with a transverse axis normal to the longitudinal axis, configured to establish a pivot link with a fixed part of the engine; and
a lubrication circuit comprising at least a first duct provided in the big end, establishing fluidic communication between an inner space of each coaxial side bearing and the third side chamber, whatever the length of the control connecting rod, and comprising at least one second duct provided in the small end, in fluidic communication with the third side chamber and opening into the eye.

2. The telescopic control connecting rod of claim 1, wherein each coaxial side bearing has a shoulder to ensure positioning along the transverse axis of the control connecting rod with respect to the fixed part of the engine.

3. The telescopic control connecting rod of claim 1, wherein the third side chamber has an annular shape, to facilitate free passage of oil from the lubrication circuit between the two coaxial side bearings of the control connecting rod.

4. The telescopic control connecting rod of claim 1, further comprising a spacer attached to each coaxial side bearing and configured to be secured to the fixed part of the engine, each spacer comprising at least one supply duct configured to supply the inner space of the coaxial side bearing with oil and to lubricate an external surface of the coaxial side bearing, when the control connecting rod is mounted in the engine.

5. The telescopic control connecting rod of claim 4, further comprising a stepped ring inserted between the coaxial side bearing and its attached spacer, to limit friction associated with oscillating movement of the control connecting rod relative to the fixed part of the engine.

6. The telescopic control connecting rod of claim 1, further comprising a control circuit, independent of the lubrication circuit, for establishing or closing fluidic communication between the first hydraulic chamber and the second hydraulic chamber.

7. The telescopic control connecting rod of claim 6, wherein the control circuit comprises a first hydraulic slide valve and a second hydraulic slide valve, respectively housed in the first and the second coaxial side bearing of the control connecting rod, wherein:
a displacement of the first hydraulic slide valve enables establishment of an oil circulation from the first hydraulic chamber to the second hydraulic chamber, via passages arranged in the big end; and
a displacement of the second hydraulic slide valve enables establishment a circulation of oil from the second hydraulic chamber to the first hydraulic chamber, via other passages arranged in the big end.

8. The telescopic control connecting rod of claim 7, wherein each hydraulic slide valve is configured to be in contact via a ball with a control piston carried by the fixed part of the engine, each control piston being able to be moved by an oil pressure of a drive circuit, independent of the lubrication circuit and the control circuit, to induce movement of the associated hydraulic slide valve.

9. The telescopic control connecting rod of claim 1, further comprising a refill circuit comprising at least one bore and a non-return valve, so as to allow oil to circulate from the third side chamber to one of the other two first and second hydraulic chambers.

10. The telescopic control connecting rod of claim 1, further comprising a discharge circuit comprising at least one bore and a non-return valve between the first hydraulic chamber or the second hydraulic chamber and an exterior of the control connecting rod, so as to discharge oil from the control circuit when the oil pressure in the control circuit exceeds a determined maximum pressure.

11. The telescopic control connecting rod of claim 2, wherein the third side chamber has an annular shape, to facilitate free passage of oil from the lubrication circuit between the two coaxial side bearings of the control connecting rod.

12. The telescopic control connecting rod of claim 11, further comprising a spacer attached to each coaxial side bearing and configured to be secured to the fixed part of the engine, each spacer comprising at least one supply duct configured to supply the inner space of the coaxial side bearing with oil and to lubricate an external surface of the coaxial side bearing, when the control connecting rod is mounted in the engine.

13. The telescopic control connecting rod of claim 12, further comprising a stepped ring inserted between the coaxial side bearing and its attached spacer, to limit friction associated with oscillating movement of the control connecting rod relative to the fixed part of the engine.

14. The telescopic control connecting rod of claim 12, further comprising a control circuit, independent of the lubrication circuit, for establishing or closing fluidic communication between the first hydraulic chamber and the second hydraulic chamber.

15. The telescopic control connecting rod of claim 14, wherein the control circuit comprises a first hydraulic slide valve and a second hydraulic slide valve, respectively housed in the first and the second coaxial side bearing of the control connecting rod, wherein:
a displacement of the first hydraulic slide valve enables establishment of an oil circulation from the first hydraulic chamber to the second hydraulic chamber, via passages arranged in the big end; and
a displacement of the second hydraulic slide valve enables establishment a circulation of oil from the second hydraulic chamber to the first hydraulic chamber, via other passages arranged in the big end.

16. The telescopic control connecting rod of claim 15, wherein each hydraulic slide valve is configured to be in contact via a ball with a control piston carried by the fixed part of the engine, each control piston being able to be moved by an oil pressure of a drive circuit, independent of the lubrication circuit and the control circuit, to induce movement of the associated hydraulic slide valve.

17. The telescopic control connecting rod of claim 15, further comprising a refill circuit comprising at least one bore and a non-return valve, so as to allow oil to circulate from the third side chamber to one of the other two first and second hydraulic chambers.

18. The telescopic control connecting rod of claim 17, further comprising a discharge circuit comprising at least one bore and a non-return valve between the first hydraulic chamber or the second hydraulic chamber and an exterior of the control connecting rod, so as to discharge oil from the control circuit when the oil pressure in the control circuit exceeds a determined maximum pressure.
